(19) United States
(12) Patent Application Publication
(10) Pub. No.: US 2025/0159214 A1
(43) Pub. Date: May 15, 2025

(54) NEURAL NETWORK-BASED IMAGE AND VIDEO COMPRESSION METHOD WITH PARALLEL PROCESSING

(71) Applicant: Bytedance Inc., Los Angeles, CA (US)

(72) Inventors: Zhaobin Zhang, San Diego, CA (US); Semih Esenlik, San Diego, CA (US); Kai Zhang, San Diego, CA (US); Li Zhang, San Diego, CA (US)

(21) Appl. No.: 19/021,539

(22) Filed: Jan. 15, 2025

Related U.S. Application Data
(63) Continuation of application No. PCT/US2023/027932, filed on Jul. 17, 2023.
(60) Provisional application No. 63/389,788, filed on Jul. 15, 2022.

(51) Int. Cl. H04N 19/189; H04N 19/119; H04N 19/176

(52) U.S. Cl. CPC H04N 19/189; H04N 19/119; H04N 19/176

(57) ABSTRACT

An image decoding method including obtaining reconstructed latents ŷ[:,:,:] using an arithmetic decoder; feeding the reconstructed latents into a synthesis neural network; tile partitioning output feature maps into multiple parts based on decoded parameters at one or multiple locations; separately feeding each of the multiple parts into a next stage of a plurality of convolutional layers to obtain spatially partitioned feature maps at an output; and cropping and stitching the spatially partitioned feature maps back to a whole feature map spatially until an image is reconstructed.

### CROSS-REFERENCE TO RELATED PATENT APPLICATIONS

This application is a continuation of International Patent Application No. PCT/US2023/027932 filed on Jul. 17, 2023, which claims the priority to and benefits of U.S. Provisional Patent Application No. 63/389,788, filed on Jul. 15, 2022. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

The disclosed aspects/embodiments provide techniques related to a neural network-based image and video compression method is proposed. The invention targets the out of memory issue when the image or video sequence is too large to fit in the memory in the decoding process, therefore leading to fail of decoding. The invention provides a tiled partitioning scheme that offers the feasibility of successful decoding from the bitstreams irrespective of the spatial size, especially beneficial for a limited memory budge or for the large resolution images/videos.

A first aspect relates to an image processing method, comprising the steps of: obtaining reconstructed latents ŷ[:,:,:]; feeding the reconstructed latents into a synthesis neural network; tile partitioning output feature maps into multiple parts based on decoded parameters at one or multiple locations; separately feeding each of the multiple parts into a next stage of a plurality of convolutional layers to obtain spatially partitioned feature maps at an output; and cropping and stitching the spatially partitioned feature maps back to a whole feature map spatially until an image is reconstructed.

A second aspect relates to an image processing method, comprising the steps of: obtaining quantized latents; obtaining parameters of tiled partitioning; and encoding the latents and the parameters of tiled partitioning into a bitstream so that a decoder receiving the bitstream is able to crop and stitch spatially partitioned feature maps back to a whole feature map spatially until an image is reconstructed.

Optionally, in any of the preceding aspects, another implementation of the aspect provides that the tiled partitioning is horizontal or vertical.

Optionally, in any of the preceding aspects, another implementation of the aspect provides that the tiled partitioning is vertical only.

Optionally, in any of the preceding aspects, another implementation of the aspect provides that the tiled partitioning is vertical, and wherein the tile partitioning is performed more than once.

Optionally, in any of the preceding aspects, another implementation of the aspect provides that the tiled partitioning is horizontal only.

Optionally, in any of the preceding aspects, another implementation of the aspect provides that the tiled partitioning is horizontal, and wherein the tile partitioning is performed more than once.

Optionally, in any of the preceding aspects, another implementation of the aspect provides that the tiled partitioning is both horizontal and vertical.

Optionally, in any of the preceding aspects, another implementation of the aspect provides that the tiled partitioning is performed recursively.

Optionally, in any of the preceding aspects, another implementation of the aspect provides that the tiled partitioning is fixed for all frames.

Optionally, in any of the preceding aspects, another implementation of the aspect provides that the tiled partitioning is different for two or more frames within a sequence.

Optionally, in any of the preceding aspects, another implementation of the aspect provides that feature map values in a first one of the parts adjacent to a partition boundary are used to pad a second one of the parts.

Optionally, in any of the preceding aspects, another implementation of the aspect provides that the tiled partitioning is inserted into one location of the synthesis neural network.

Optionally, in any of the preceding aspects, another implementation of the aspect provides that the tiled partitioning is inserted into multiple locations of the synthesis neural network.

Optionally, in any of the preceding aspects, another implementation of the aspect provides that a padding size for each subpart is controllable, and wherein the padding size for different subparts is the same or different.

Optionally, in any of the preceding aspects, another implementation of the aspect provides encoding one or more of a padding size, a number of vertical partitions, and a number of horizontal partitions into the bitstream.

Optionally, in any of the preceding aspects, another implementation of the aspect provides that the bitstream includes a number of tiles used to decode the bitstream.

Optionally, in any of the preceding aspects, another implementation of the aspect provides that the bitstream includes a first indication and a second indication, wherein one part of the synthesis neural network is partitioned using the first indication, and wherein another part of the synthesis neural network is partitioned using the second indication.

Optionally, in any of the preceding aspects, another implementation of the aspect provides that the bitstream includes a layer identifier, and wherein the layer identifier identifies a layer of the synthesis neural network.

Optionally, in any of the preceding aspects, another implementation of the aspect provides that the layer identifier indicates a starting layer after which the tile partitioning is performed.

Optionally, in any of the preceding aspects, another implementation of the aspect provides that the layer identifier indicates a starting layer after which the tile partitioning is stopped.

Optionally, in any of the preceding aspects, another implementation of the aspect provides that the layer identifier indicates a starting layer after which a specified number of tiles are applied, and wherein the specified number of times is indicated in the bitstream.

Optionally, in any of the preceding aspects, another implementation of the aspect provides that the layer identifier indicates a starting layer after which a specified number of tiles are no longer applied.

Optionally, in any of the preceding aspects, another implementation of the aspect provides that the layer identifier comprises an index to a table, and wherein the table comprises information about an association of indices and layers of the synthesis neural network.

Optionally, in any of the preceding aspects, another implementation of the aspect provides that the bitstream includes an indicator that indicates a size of a tile.

Optionally, in any of the preceding aspects, another implementation of the aspect provides that the bitstream includes an indicator that indicates a position of a tile.

Optionally, in any of the preceding aspects, another implementation of the aspect provides that the bitstream includes an indicator that indicates whether or not the tile partitioning is applied, and wherein neural network-based image reconstruction is performed when the tile partitioning is not applied.

Optionally, in any of the preceding aspects, another implementation of the aspect provides that the bitstream includes an indicator that indicates a minimum tile size, and wherein the minimum tile size is used to determine a number of tiles.

Optionally, in any of the preceding aspects, another implementation of the aspect provides that a size of the reconstructed image is also used to determine the number of tiles.

Optionally, in any of the preceding aspects, another implementation of the aspect provides that a size of the output feature maps is also used to determine the number of tiles.

Optionally, in any of the preceding aspects, another implementation of the aspect provides that the bitstream includes an indicator that indicates a size of the reconstructed image, and wherein the size of the reconstructed image is used to determine the number of tiles.

Optionally, in any of the preceding aspects, another implementation of the aspect provides that a number of tiles to be used is based on a size of an input feature map.

Optionally, in any of the preceding aspects, another implementation of the aspect provides that a layer of the synthesis neural network applies partition tiling based on a size of an input feature map, and wherein a determination of whether to apply the partition tiling is performed before application of the layer.

Optionally, in any of the preceding aspects, another implementation of the aspect provides that a layer of the synthesis neural network applies partition tiling based on a size of an input feature map, and a determination of the number of tiles to use is performed before application of the layer.

Optionally, in any of the preceding aspects, another implementation of the aspect provides that two or more of the tiles are independently decoded.

Optionally, in any of the preceding aspects, another implementation of the aspect provides that decoding of a second tile is dependent upon decoding of a first tile.

Optionally, in any of the preceding aspects, another implementation of the aspect provides that the bitstream includes an indicator indicating whether or not two or more of the tiles are independently decoded.

Optionally, in any of the preceding aspects, another implementation of the aspect provides that a boundary of two tiles is filtered.

Optionally, in any of the preceding aspects, another implementation of the aspect provides that an intermediate tensor size reaches a maximum before a last inverse convolution or pixel shuffle layer in a synthesis transform.

Optionally, in any of the preceding aspects, another implementation of the aspect provides that ŷ[C, h₄, w₄] is tiled with overlap to control maximum memory size of intermediate latent tensors, wherein ŷ[C, h₄, w₄] represents a latent space tensor ŷ of size [C, h₄, w₄], and wherein C represents a channel, h represents a height of a tensor, and w represents a width of the tensor.

Optionally, in any of the preceding aspects, another implementation of the aspect provides that a tile location and a tile size are signalled in the bitstream independently for primary components and for secondary components.

Optionally, in any of the preceding aspects, another implementation of the aspect provides that each tile goes through synthesis transform independently.

Optionally, in any of the preceding aspects, another implementation of the aspect provides that tiles are stitched to each other after reconstruction, and wherein overlapping areas of tile are discarded.

Optionally, in any of the preceding aspects, another implementation of the aspect provides that the bitstream includes one or both of a tile enable luma flag and a tile enable chroma flag for tiling of the primary components and the secondary components.

Optionally, in any of the preceding aspects, another implementation of the aspect provides that the bitstream includes one or both of a tile size luma syntax element and a tile size chroma syntax element for the primary components and the secondary components.

Optionally, in any of the preceding aspects, another implementation of the aspect provides that the bitstream includes one or both of a tile overlap luma syntax element and a tile overlap chroma syntax element for the primary components and the secondary components.

Optionally, in any of the preceding aspects, another implementation of the aspect provides that the reconstructed latents are obtained using an arithmetic decoder.

A third aspect relates to an apparatus for processing video data comprising: a processor; and a non-transitory memory with instructions thereon, wherein the instructions upon execution by the processor, cause the processor to perform the method of any of the disclosed embodiments.

A fourth aspect relates to a non-transitory computer readable medium comprising a computer program product for use by a video coding device, the computer program product comprising computer executable instructions stored on the non-transitory computer readable medium such that when executed by a processor cause the video coding device to perform the method of any of the disclosed embodiments.

A fifth aspect relates to a non-transitory computer-readable recording medium storing a bitstream of a video which is generated by a method performed by a video processing apparatus, wherein the method comprises the method of any of the disclosed embodiments.

A sixth aspect relates to a method for storing bitstream of a video comprising the method of any of the disclosed embodiments.

A seventh aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a typical transform coding scheme.

FIG. 2 illustrates an example of a quantized latent when hyper encoder/decoder are used.

FIG. 3 illustrates an example of a network architecture of an autoencoder implementing a hyperprior model.

FIG. 4 illustrates a combined model jointly optimizing an autoregressive component that estimates the probability distributions of latents from their causal context (i.e., context model) along with a hyperprior and the underlying autoencoder.

FIG. 5 illustrates an encoding process utilizing a hyper encoder and a hyper decoder.

FIG. 6 illustrates an example decoding process.

FIG. 7 illustrates an example implementation of encoding and decoding processes.

FIG. 8 illustrates a 2-dimensional forward wavelet transform.

FIG. 9 illustrates a possible splitting of the latent representation after the 2D forward transform.

FIG. 10A illustrates that the spatial size is intensively increased after feeding through the synthesis network.

FIG. 10B illustrates that the number of pixels along one edge of the feature maps may be 16 times as that of before the synthesis network.

FIG. 11 illustrates a detailed spatial size changing when the feature maps move through the synthesis network.

FIG. 12 illustrates a tiled partition of the feature maps for synthesis network.

FIG. 13 illustrates an example of the tiled partitioning is inserted into the synthesis network.

FIG. 14 is a block diagram showing an example video processing system.

FIG. 15 is a block diagram of an example video processing apparatus.

FIG. 16 is a flowchart for an example method of video processing.

FIG. 17 is a block diagram that illustrates an example video coding system.

FIG. 18 is a block diagram that illustrates an example encoder.

FIG. 19 is a block diagram that illustrates an example decoder.

FIG. 20 is a schematic diagram of an example encoder.

FIG. 21 is an image decoding method according to an embodiment of the disclosure.

FIG. 22 is an image encoding method according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, the techniques described herein are applicable to other video codec protocols and designs.

### 1. Summary

A neural network based image and video compression method comprising an auto-regressive subnetwork and an entropy coding engine, wherein entropy coding is performed independently of the auto-regressive subnetwork.

### 1. Background

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half-decade. It is reported that the latest neural network-based image compression algorithm [1] achieves comparable rate distortion (R-D) performance with Versatile Video Coding (VVC) [2], the latest video coding standard developed by Joint Video Experts Team (JVET) with experts from Moving Picture Experts Group (MPEG) and Video Coding Experts Group (VCEG). With the performance of neural image compression continually being improved, neural network-based video compression has become an actively developing research area. However, neural network-based video coding still remains in its infancy due to the inherent difficulty of the problem.

### 2.1 Image/Video Compression.

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., discrete cosine transform (DCT) or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations International Organization for Standardization (ISO)/International Electrotechnical Commission (IEC) has two expert groups namely Joint Photographic Experts Group (JPEG) and Moving Picture Experts Group (MPEG), and International Telecommunication Union-Telecommunication Standardization Sector (ITU-T) also has its own Video Coding Experts Group (VCEG) which is for standardization of image/video coding technology. The influential video coding standards published by these organizations include JPEG, JPEG 2000, H.262, H.264/Advanced Video Coding (AVC) and H.265/High Efficiency Video Coding (HEVC). After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new technique since there were a number of researchers working on neural network-based image coding [3]. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2 Neural Networks.

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression.

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling.

According to Shannon's information theory [6], the optimal method for lossless coding can reach the minimal coding rate—log₂ p(x) where p(x) is the probability of symbol x. A number of lossless coding methods were developed in literature and among them arithmetic coding is believed to be among the optimal ones [7]. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$( 1 )$$

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red green blue (RGB) color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Most of the compression methods directly model the probability distribution in the pixel domain. Some researchers also attempt to model the probability distribution as a conditional one upon explicit or latent representations. That being said, we may estimate

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h) p(x|h), meaning the modeling is split into an unconditional one and a conditional one. The additional condition can be image label information or high-level representations.

### 2.3.2 Auto-Encoder.

Auto-encoder originates from the well-known work proposed by Hinton and Salakhutdinov [17]. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

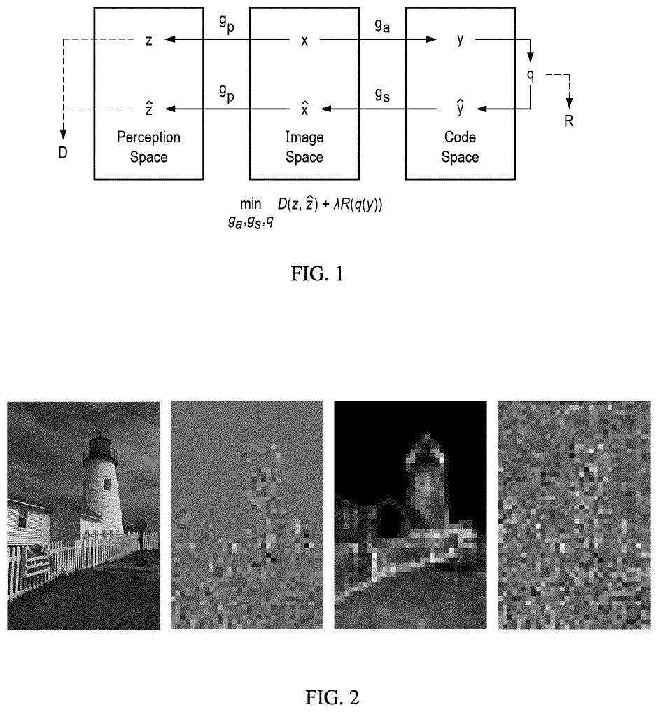

FIG. 1 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image \hat{x}. The distortion is calculated in a perceptual space by transforming x and \hat{x} with the function gₚ.

It is intuitive to apply auto-encoder network to lossy image compression. We only need to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges. First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 1, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation y, and A is the Lagrange multiplier. It should be noted that D can be calculated in either pixel domain or perceptual domain. All existing research works follow this prototype and the difference might only be the network structure or loss function.

In terms of network structure, recurrent neural networks (RNNs) and convolutional neural networks (CNNs) are the most widely used architectures. In the RNNs relevant category, Toderici et al. [18] propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. [19] then proposed an improved version by upgrading the encoder with a neural network similar to pixel RNN (PixelRNN) to compress the binary codes. The performance is reportedly better than JPEG on Kodak image dataset using multi-scale structural similarity (MS-SSIM) evaluation metric. Johnston et al. [20] further improve the RNN-based solution by introducing hidden-state priming. In addition, an SSIM-weighted loss function is also designed, and spatially adaptive bitrates mechanism is enabled. They achieve better results than better portable graphics (BPG) on Kodak image dataset using MS-SSIM as evaluation metric. Covell et al. [21] support spatially adaptive bitrates by training stop-code tolerant RNNs.

Ballé et al. [22] proposes a general framework for rate-distortion optimized image compression. The use multiary quantization to generate integer codes and consider the rate during training, i.e. the loss is the joint rate-distortion cost, which can be mean square error (MSE) or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in [23]. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. [25] improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. [26] further exploit the structures in the residue space by introducing an autoregressive model to estimate both the standard deviation and the mean. In the latest work [27], Z. Cheng et al. use Gaussian mixture model to further remove redundancy in the residue. The reported performance is on par with VVC [28] on the Kodak image set using peak signal-to-noise ratio (PSNR) as evaluation metric.

### 2.3.3 Hyper Prior Model.

In the transform coding approach to image compression, the encoder subnetwork (section 2.3.2) transforms the image vector x using a parametric analysis transform gₐ(x,Ø_{g}) into a latent representation y, which is then quantized to form ŷ. Because ŷ is discrete-valued, it can be losslessly compressed using entropy coding techniques such as arithmetic coding and transmitted as a sequence of bits.

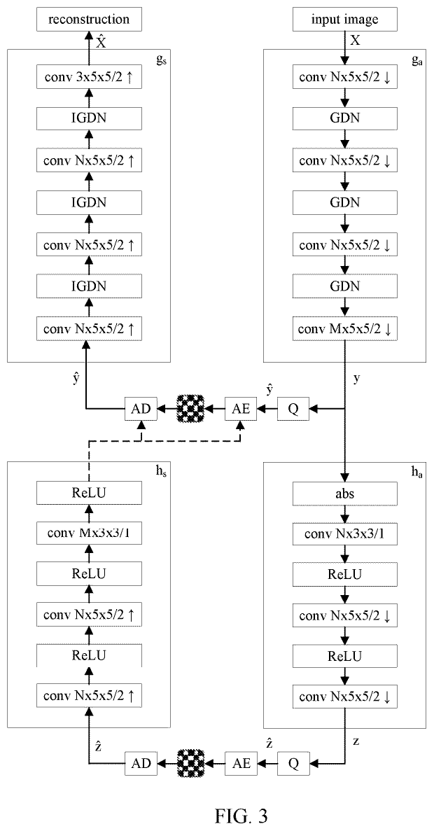

As evident from the middle left and middle right image of FIG. 2, there are significant spatial dependencies among the elements of ŷ. Notably, their scales (middle right image) appear to be coupled spatially. In [25] an additional set of random variables \hat{z} are introduced to capture the spatial dependencies and to further reduce the redundancies. In this case, the image compression network is depicted in FIG. 3.

In FIG. 3, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recover ŷ as well. It then feeds ý into gₛ to obtain the reconstructed image.

When the hyper encoder and hyper decoder are added to the image compression network, the spatial redundancies of the quantized latent ŷ are reduced. The rightmost image in FIG. 2 correspond to the quantized latent when hyper encoder/decoder are used. Compared to middle right image, the spatial redundancies are significantly reduced, as the samples of the quantized latent are less correlated.

In FIG. 2, an image from the Kodak dataset is shown on the left; the visualization of the latent representation y of that image is shown on the middle left; the standard deviations σ of the latent are shown on the middle right; and latents y after the hyper prior (hyper encoder and decoder) network are shown on the right.

FIG. 3 illustrates a network architecture of an autoencoder implementing the hyperprior model. The left side shows an image of an autoencoder network, the right side corresponds to the hyperprior subnetwork. The analysis and synthesis transforms are denoted as gₐ and gₛ, respectively. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitstream and transmitted to the receiver (decoder) along with y.

### 2.3.4 Context Model.

Although the hyperprior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to the process. For example, the context model subnetwork generates one sample of a latent, which is later used as input to obtain the next sample.

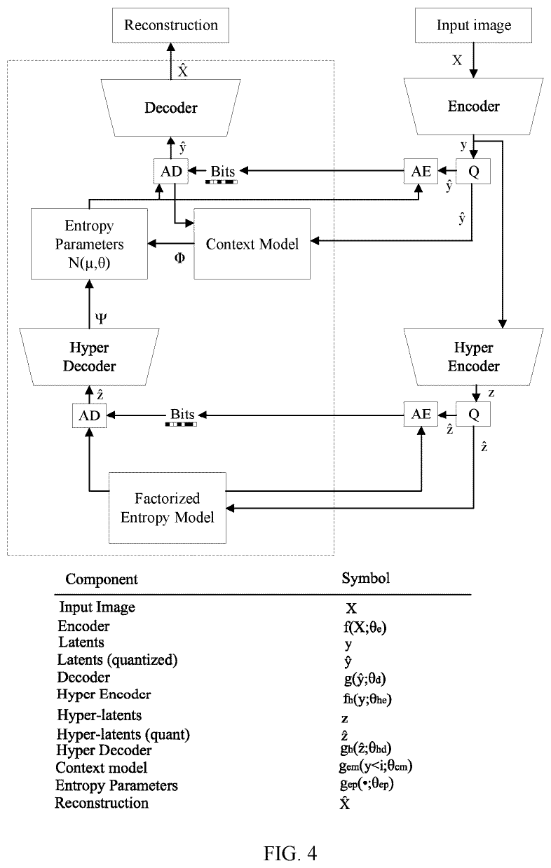

The authors in [26] utilize a joint architecture where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 4, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ý from the bitstream by arithmetic decoder (AD) module.

FIG. 4 illustrates the combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In [26] and according to FIG. 4, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 the Encoding Process Using Joint Auto-Regressive Hyper Prior Model.

FIG. 4 corresponds to the state of the art compression method that is proposed in [26]. In this section and the next, the encoding and decoding processes will be described separately.

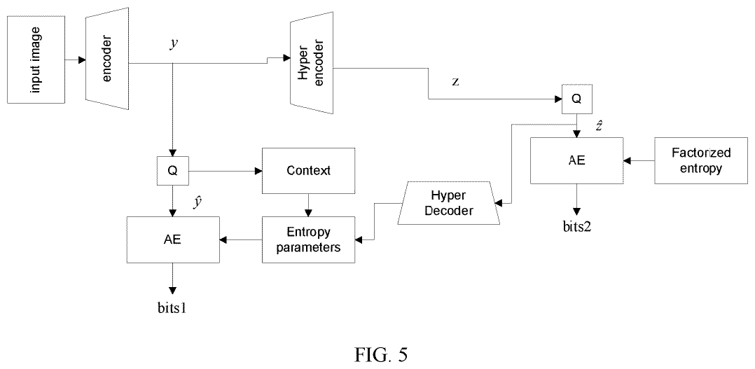

FIG. 5 illustrates the encoding process according to [26].

In FIG. 5, the encoding process is depicted. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. In [26] the entropy parameters module are used to estimate the mean and the variance values.

The subnetwork hyper decoder generates part of the information used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process.

It is noted that the other names can be used for the modules described above.

In the above description, the all of the elements in FIG. 5 are collectively the encoder. The analysis transform that converts the input image into latent representation is also called an encoder (or auto-encoder).

### 2.3.6. The Decoding Process Using Joint Auto-Regressive Hyper Prior Model.

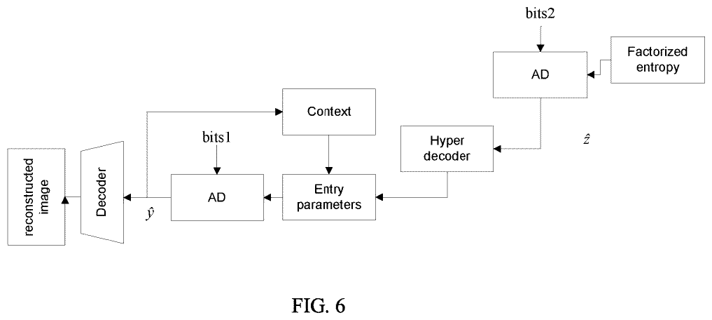

FIG. 6 illustrates the decoding process corresponding to [26]. FIG. 6 depicts the decoding process separately corresponding to [26].

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally, the fully reconstructed quantized latent ŷ is input to the synthesis transform (denoted as decoder in FIG. 6) module to obtain the reconstructed image.

In the above description, the all of the elements in FIG. 6 are collectively called decoder. The synthesis transform that converts the quantized latent into reconstructed image is also called a decoder (or auto-decoder).

### 2.3.7. Wavelet Based Neural Compression Architecture.

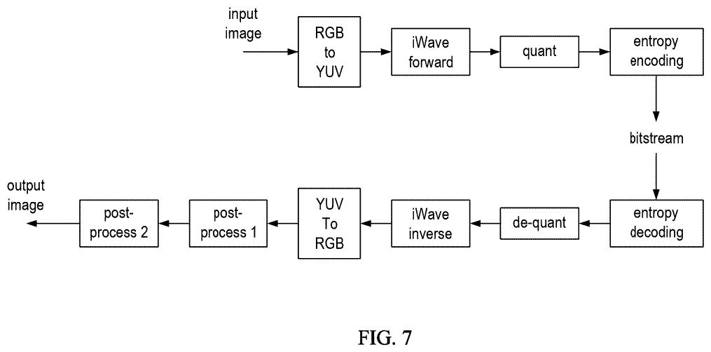

The analysis transform (denoted as encoder) in FIG. 5 and the synthesis transform (denoted as decoder) in FIG. 6 might be replaced by a wavelet based transform. FIG. 7 illustrates an example implementation of the wavelet based transform. In the figure, first the input image is converted from an RGB color format to a YUV color format. This conversion process is optional, and can be missing in other implementations. If however such a conversion is applied at the input image, a back conversion (from YUV to RGB) is also applied before the output image is generated. Moreover there are 2 additional post processing modules (post-process 1 and 2) shown in the figure. These modules are also optional, hence might be missing in other implementations. The core of an encoder with wavelet-based transform is composed of a wavelet-based forward transform, a quantization module and an entropy coding module. After these 3 modules are applied to the input image, the bitstream is generated. The core of the decoding process is composed of entropy decoding, de-quantization process and an inverse wavelet-based transform operation. The decoding process convers the bitstream into output image. The encoding and decoding processes are depicted below in FIG. 7.

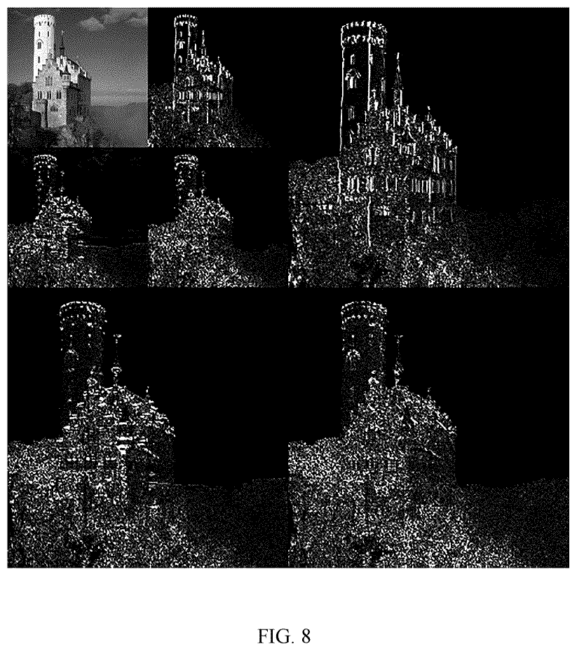

After the wavelet-based forward transform is applied to the input image, in the output of the wavelet-based forward transform the image is split into its frequency components. The output of a 2-dimensional (2D) forward wavelet transform (depicted as iWave forward module in the figure) might take the form depicted in FIG. 8. The input of the transform is an image of a castle. In the example, after the transform an output with 7 distinct regions are obtained. The number of distinct regions depend on the specific implementation of the transform and might different from 7. Potential number of regions are 4, 7, 10, 13, . . . .

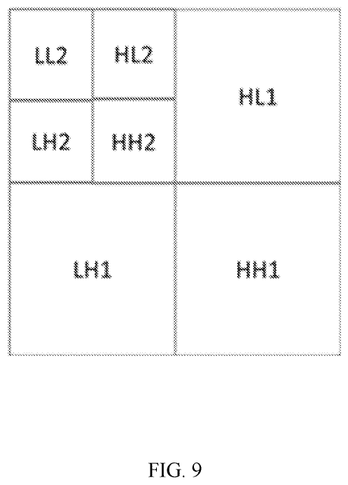

FIG. 9 illustrates a possible splitting of the latent representation after the two dimensional (2D) forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 7) to obtain the reconstructed image.

### 2.4 Neural Networks for Video Compression.

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1 Low-Latency.

[29] are the first to propose a video compression scheme with trained neural networks. They first split the video sequence frames into blocks and each block will choose one from two available modes, either intra coding or inter coding. When intra coding is selected, there is an associated auto-encoder to compress the block. When inter coding is selected, motion estimation and compensation are performed with tradition methods and a trained neural network will be used for residue compression. The outputs of auto-encoders are directly quantized and coded by the Huffman method.

Chen et al. [31] propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme [34]. This scheme performs on par with H.264.

Lu et al. [32] propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264.

Rippel et al. [33] propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in multi-scale structural similarity (MS-SSIM) than HEVC reference software.

J. Lin et al. [36] propose an extended end-to-end neural network-based video compression framework based on [32]. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than and H.265 by a noticeable margin in terms of both peak signal-to-noise ratio (PSNR) and MS-SSIM.

Eirikur et al. [37] propose scale-space flow to replace commonly used optical flow by adding a scale parameter based on framework of [32]. It is reportedly achieving better performance than H.264.

Z. Hu et al. [38] propose a multi-resolution representation for optical flows based on [32]. Concretely, the motion estimation network produces multiple optical flows with different resolutions and let the network to learn which one to choose under the loss function. The performance is slightly improved compared with and better than H.265.

### 2.4.2 Random Access.

Wu et al. [30] propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. [41] propose a method for interpolation-based video compression, wherein the interpolation model combines motion information compression and image synthesis, and the same auto-encoder is used for image and residual.

Amirhossein et al. [35] propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the latent representations. It provides comparative performance as H.265.

### 2.5 Preliminaries.

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bits per pixel (bpp). Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=2⁸, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max ( [symbol] ) is the maximal value in [symbol] , e.g., 255 for 8-bit grayscale images. There are other quality evaluation metrics such as structural similarity (SSIM) and multi-scale SSIM (MS-SSIM) [4].

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate) [5]. There are other important aspects to evaluate image/video coding schemes, including encoding/decoding complexity, scalability, robustness, and so on.

### 3. Problems

### 3.1 Core Problem

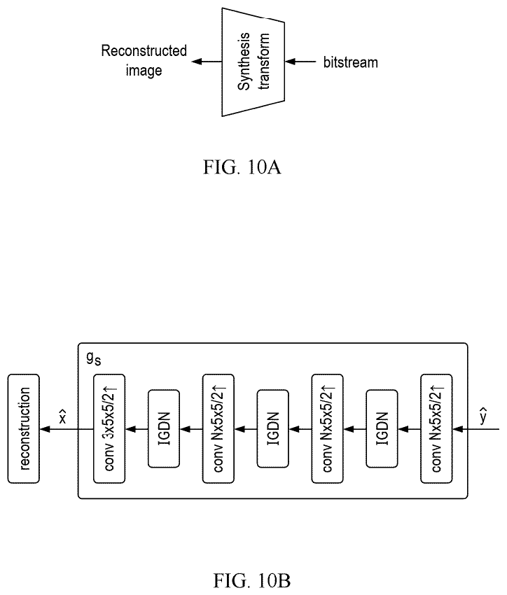

The state-of-the-art image compression network typically involves a synthesis network to reconstruct the image from the bitstreams. As illustrated in FIG. 10A, the spatial size is intensively increased after feeding through the synthesis network, for example in FIG. 10B, the number of pixels along one edge of the feature maps may be 16 times as that of before the synthesis network. This is a critical challenge when facing the limited memory or if the image/video is in large resolution, which will lead to crash of the decoder.

### 3.2 Details of the Problem.

The typical feature maps of the neural networks are 3-dimensional (3D) array with the three dimensions indicating channel, width and height, respectively (note that different methods may be used to slicing the array). The spatial size of the feature maps is significantly enlarged when they are fed through the synthesis network. For an example, the initial feature maps are with spatial size of 4×4, after 4 times of ×2 upsampling, the spatial size reaches 64×64. In addition, the convolutional kernel is a 4-dimensional array. The computational resource required for the synthesis network is increasing exponentially with the spatial size increasing. Nowadays, the high-definition video content is increasing at a rapid speed and more 2 k/4 k content is emerging. It is challenging for a neural network-based decoder to decode these contents with a limited memory budget.

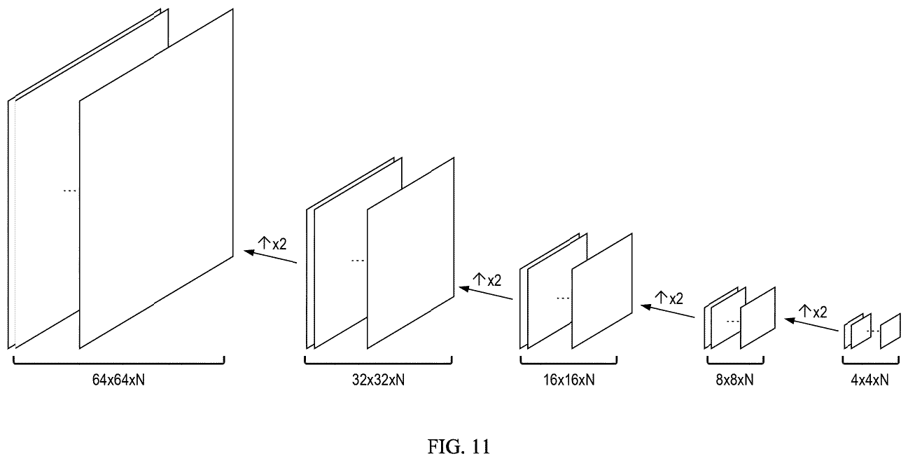

FIG. 11 illustrates a detailed spatial size changing when the feature maps move through the synthesis network.

### 4. The Present Disclosure

The detailed embodiments herein should be considered as examples to explain general concepts. These embodiments should not be interpreted in a narrow way. Furthermore, these embodiments can be combined in any manner.

### 4.1 Target of the Present Disclosure.

The target of the present disclosure is to solve the potential out of memory issue due to limited memory or over large reconstructed image/video sequence size.

### 4.2 Core of the Present Disclosure.

The core of the present disclosure offers a flexible and manageable feature map spatial size in reconstructing the images using synthesis network. Note that the methods described below may be also applicable to certain area within an image/frame/picture, e.g., they may be applied to a slice within an image.

### 4.3 an Embodiment of the p Illustrates a Tiled Partition of the Feature Maps for Synthesis Network.

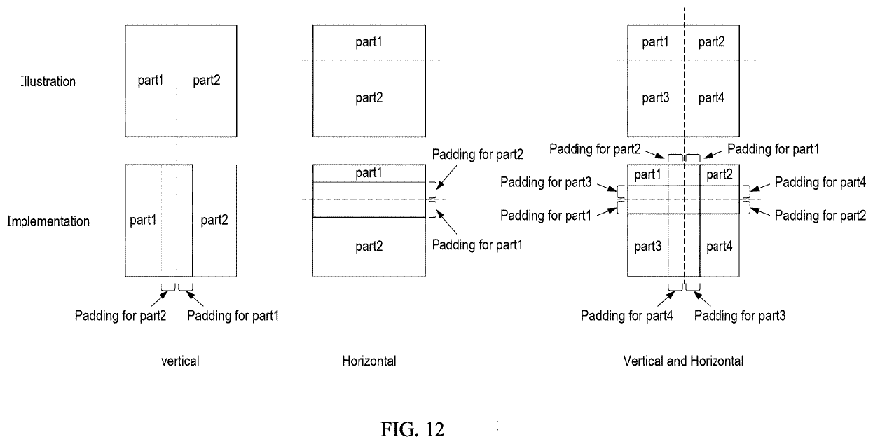

The embodiments described herein provide a flexible scheme that controls the spatial size of the feature maps via tiled partitioning. As illustrated in FIG. 12, instead of feeding the whole feature maps to the next convolution layers, the proposed embodiments partition the feature maps spatially into multiple parts to reduce memory consumption and stitch them back into a single one after the computation is completed. In addition, to reduce the distortion by the boundary effects, there is an overlapped area for each part, namely tiled partition.

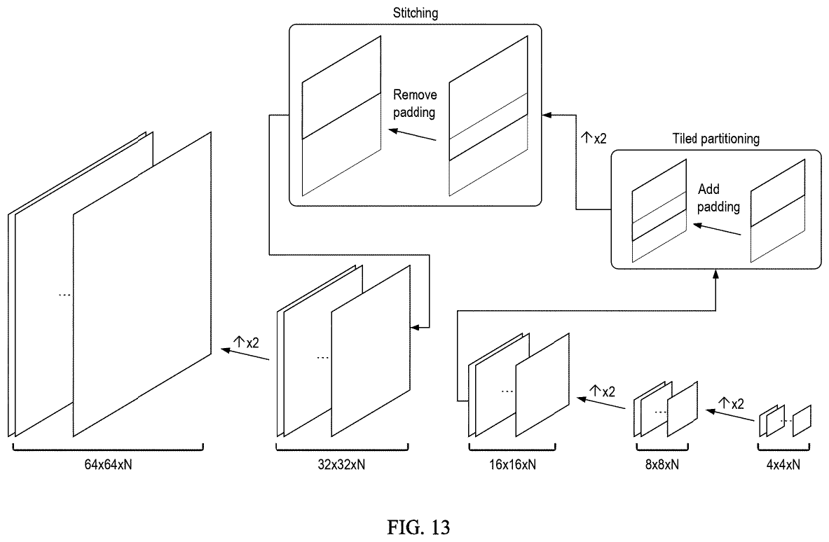

FIG. 13 illustrates an example of the tiled partitioning is inserted into the synthesis network.

In the following sections, a “frame”, a “picture” or an “image” might have the same meaning. Alternatively, the “frame/picture/image” below may be replaced by a region within the “frame/picture/image”.
1. The tiled partitioning could be horizontal, vertical or both horizontal and vertical.
a. As illustrated in the leftmost subfigure in FIG. 12, the partitioning can be vertical only.
i. The tiled partitioning can be vertically partitioned once or more than once.
b. As illustrated in the middle subfigure in FIG. 12, the partitioning can be horizontal only.
i. The tiled partitioning can be horizontally partitioned once or more than once.
c. As illustrated in the rightmost subfigure in FIG. 12, the partitioning can be both vertical and horizontal.
i. The tiled partitioning can be recursively performed.
2. The tiled partitioning may be fixed for all frames within a sequence.
a. Alternatively, it may be different for two frames within a sequence.
3. There are multiple ways to fill the padding area.
a. In one example, the adjacent feature map values can be used to fill the padding area. For example, in FIG. 12 vertical partition, feature map values in part2 adjacent to the partition boundary can be used to pad part1.
4. The tiled partitioning could be inserted to one or multiple locations of the synthesis network.
a. In one example, the tiled partitioning can be inserted into one location, as illustrated in FIG. 13.
b. In one example, the tiled partitioning can be inserted at multiple locations of the synthesis network.
5. The padding size for each subpart is controllable and may be the same or different.
6. The associated parameters may be encoded into the bitstreams, such as the padding size, the number of vertical partitions or horizontal partitions.

### 4.4 Signaling of the Tiles.

Additionally or alternatively, according to the present disclosure, the following can be implemented.
1. An indication might be included in the bitstream to indicate the number of tiles that are used in decoding a bitstream.
a. In one specific implementation, at least 2 indications are included in the bitstream. One part of the neural network that is used in generating the reconstructed image is partitioned according to the first indication, and the second part of the neural network is partitioned according to the second indication.
2. Additionally or alternatively an indication might be included in the bitstream to indicate the layer information (e.g., a layer id, i.e. to indicate which layer of the decoding neural network).
a. The layer id can indicate a starting layer, after which tiling is performed.
b. The layer id can indicate a starting layer, after which tiling is stopped.
c. The layer id can indicate a starting layer, after which a specified number of tiles are applied. The number of tiles might be indicated in the bitstream or can be predefined.
d. The layer id might indicate a starting layer, after which a specified number of tiles are not applied anymore.
e. The layer id might be an index to a table, wherein the table comprises information about the association of indices and the layers of the decoding neural network.
3. Additionally or alternatively an indication might be included in the bitstream to indicate a size of a tile.
4. Additionally or alternatively an indication might be included in the bitstream to indicate a position of a tile.
5. Additionally or alternatively an indication might be included in the bitstream to indicate whether tiling is applied or not. If the indication indicates that no tiles are used, then the neural network based image reconstruction (i.e. decoding) is performed without application of tiling.
6. Additionally or alternatively an indication might be included in the bitstream to indicate a minimum size, according to which the number of tiles are determined.
a. The said minimum size and a size indicating the size of the reconstructed image can be used to determine the number of tiles.
b. The said minimum size and a size indicating the size of a feature map can be used to determine the number of tiles.

### 4.5 Inference of the Tiles.

Additionally or alternatively, according to the present disclosure the following can be implemented.
1. An indication might be included in the bitstream to indicate the size of the reconstructed image. The number of tiles to be used is determined based on the size information.
2. The number of tiles to be used might be determined based on the size input feature map. The neural network based decoder is typically composed of multiple processing layers, and the input of each layer (which is the output of the previous processing layer in order), is called a feature map. According to the invention, a size of a feature map might be used to determine the number of tiles to be used.
3. A layer of the neural network might apply tiling based on the size of its input feature map. A check might be performed before the application of the layer in order to determine whether tiling applied.
4. A layer of the neural network might apply tiling based on the size of its input feature map. A check might be performed before the application of the layer in order to determine number of tiles that are used.

### 4.6 Interaction Between Tiles.

5. In one example, two tiles may be independently decoded.
6. In one example, decoding of one tile may depend on the decoding of another tile.
7. In one example, whether two tiles are decoded independently or not may be signaled in the bitstream.
8. In one example, a further process may be applied on tiles.
9. For example, the boundary of two tiles may be filtered.

The solutions listed in the present disclosure might be used for compressing an image, compressing a video, compression part of an image or compressing part of a video.

### 4.7 Benefits of the Present Disclosure.

The present disclosure provides a method of spatially partitioning the feature maps in the synthesis network into multiple parts and perform computation one-by-one on each of the parts. Therefore, the memory requirement is reduced. In addition, the flexible control of the tiled partitioning parameters, such as the way of filled the padding area, offers another possibility to improve the coding performance.

### 5. Embodiments of the Present Disclosure

The detailed embodiments below should be considered as examples to explain general concepts. These embodiments should not be interpreted in a narrow way. Furthermore, these embodiments can be combined in any manner.
1. An image decoding method, comprising the steps of: obtaining, the reconstructed latents ŷ[:,:,:] using the arithmetic decoder; the reconstructed latents are fed into the synthesis neural network; based on the decoded parameters for tiled partitioning, at one or multiple locations, the output feature maps are tiled partitioned into multiple parts; each part is separately fed into the next stage of convolutional layers to obtain the output spatially partitioned feature maps; the spatially partitioned feature maps are cropped and stitched back to a whole feature map spatially; and proceed until the image is reconstructed.
2. An image encoding method, comprising the steps of: obtain the quantized latents and tiled partitioning parameters; and encode the latents and partitioning parameters into the bitstreams.

Further details regarding the referenced documents may be found in:
[1] Z. Cheng, H. Sun, M. Takeuchi and J. Katto, “Learned image compression with discretized gaussian mixture likelihoods and attention modules,” in Proceedings of the IEEE/CVF Conference on Computer Vision and Pattern Recognition, pp. 7939-7948, 2020.
[2] B. Bross, J. Chen, S. Liu and Y.-K. Wang, “Versatile Video Draft (Draft 10),” JVET-S2001, July 2020.
[3] R. D. Dony and S. Haykin, “Neural network approaches to image compression,” Proceedings of the IEEE, vol. 83, no. 2, pp. 288-303, 1995.
[4] Z. Wang, A. C. Bovik, H. R. Sheikh, and E. P. Simoncelli, “Image quality assessment: From error visibility to structural similarity,” IEEE Transactions on Image Processing, vol. 13, no. 4, pp. 600-612, 2004.
[5] G. Bjontegaard, “Calculation of average PSNR differences between RD-curves,” VCEG, Tech. Rep. VCEG-M33, 2001.
[6] C. E. Shannon, “A mathematical theory of communication,” Bell System Technical Journal, vol. 27, no. 3, pp. 379-423, 1948.
[17] G. E. Hinton and R. R. Salakhutdinov, “Reducing the dimensionality of data with neural networks,” Science, vol. 313, no. 5786, pp. 504-507, 2006.
[18] G. Toderici, S. M. O'Malley, S. J. Hwang, D. Vincent, D. Minnen, S. Baluja, M. Covell, and R. Sukthankar, “Variable rate image compression with recurrent neural networks,” arXiv preprint arXiv: 1511.06085, 2015.
[19] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[20] N. Johnston, D. Vincent, D. Minnen, M. Covell, S. Singh, T. Chinen, S. Jin Hwang, J. Shor, and G. Toderici, “Improved lossy image compression with priming and spatially adaptive bit rates for recurrent networks,” in CVPR, 2018, pp. 4385-4393.
[21] M. Covell, N. Johnston, D. Minnen, S. J. Hwang, J. Shor, S. Singh, D. Vincent, and G. Toderici, “Target-quality image compression with recurrent, convolutional neural networks,” arXiv preprint arXiv: 1705.06687, 2017.
[22] J. Ballé, V. Laparra, and E. P. Simoncelli, “End-to-end optimization of nonlinear transform codes for perceptual quality,” in PCS. IEEE, 2016, pp. 1-5.
[23] J. Ballé, “Efficient nonlinear transforms for lossy image compression,” in 'PCS, 2018, pp. 248-252.
[24] J. Ballé, V. Laparra and E. P. Simoncelli, “End-to-end optimized image compression,” in International Conference on Learning Representations, 2017.
[25] J. Ballé, D. Minnen, S. Singh, S. Hwang and N. Johnston, “Variational image compression with a scale hyperprior,” in International Conference on Learning Representations, 2018.
[26] D. Minnen, J. Ballé, G. Toderici, “Joint Autoregressive and Hierarchical Priors for Learned Image Compression”, arXiv.1809.02736. 1, 2, 3, 4, 7
[27] Z. Cheng, H. Sun M. Takeuchi and J. Katto, “Learned image compression with discretized Gaussian mixture likelihoods and attention modules,” in Proceedings of the IEEE/CVF Conference on Computer Vision and Pattern Recognition (CVPR), 2020.
[28] Github repository “CompressAI: https://github.com/InterDigitalInc/CompressAI,”, InterDigital Inc, accessed December 2020.
[29] T. Chen, H. Liu, Q. Shen, T. Yue, X. Cao, and Z. Ma, “DeepCoder: A deep neural network based video compression,” in VCIP. IEEE, 2017, pp. 1-4.
[30] C.-Y. Wu, N. Singhal, and P. Krahenbuhl, “Video compression through image interpolation,” in Proceedings of the European Conference on Computer Vision (ECCV), 2018, pp. 416-431.
[31] Z. Chen, T. He, X. Jin, and F. Wu, “Learning for video compression,” IEEE Transactions on Circuits and Systems for Video Technology, DOI: 10.1109/TCSVT.2019.2892608, 2019.
[32] G. Lu, W. Ouyang, D. Xu, X. Zhang, C. Cai, and Z. Gao, “DVC: An end-to-end deep video compression framework,” in Proceedings of the IEEE/CVF Conference on Computer Vision and Pattern Recognition (CVPR), 2019.
[33] O. Rippel, S. Nair, C. Lew, S. Branson, A. Anderson and L. Bourdev, “Learned Video Compression,” 2019 IEEE/CVF International Conference on Computer Vision (ICCV), Seoul, Korea (South), 2019, pp. 3453-3462, doi: 10.1109/ICCV.2019.00355.
[34] G. Toderici, D. Vincent, N. Johnston, S. J. Hwang, D. Minnen, J. Shor, and M. Covell, “Full resolution image compression with recurrent neural networks,” in CVPR, 2017, pp. 5306-5314.
[35] A. Habibian, T. Rozendaal, J. Tomczak and T. Cohen, “Video Compression with Rate-Distortion Autoencoders,” in Proceedings of the IEEE/CVF International Conference on Computer Vision (ICCV), 2019, pp. 7033-7042.
[36] J. Lin, D. Liu, H. Li and F. Wu, “M-LVC: Multiple frames prediction for learned video compression,” in Proceedings of the IEEE/CVF Conference on Computer Vision and Pattern Recognition (CVPR), 2020.
[37] E. Agustsson, D. Minnen, N. Johnston, J. Ballé, S. J. Hwang and G. Toderici, “Scale-Space Flow for End-to-End Optimized Video Compression,” 2020 IEEE/CVF Conference on Computer Vision and Pattern Recognition (CVPR), Seattle, WA, USA, 2020, pp. 8500-8509, doi: 10.1109/CVPR42600.2020.00853.
[38] X. Hu, Z. Chen, D. Xu, G. Lu, W. Ouyang and S. Gu, “Improving deep video compression by resolution-adaptive flow coding,” in European Conference on Computer Vision (ECCV) 2020.
[39] B. Li, H. Li, L. Li and J. Zhang, “A Domain Rate Control Algorithm for High Efficiency Video Coding,” in IEEE Transactions on Image Processing, vol. 23, no. 9, pp. 3841-3854 September 2014, doi: 10.1109/TIP.2014.2336550.
[40] L. Li, B. Li, H. Li and C. W. Chen, “A Domain Optimal Bit Allocation Algorithm for High Efficiency Video Coding,” in IEEE Transactions on Circuits and Systems for Video Technology, vol. 28, no. 1, pp. 130-142, January 2018, doi: 10.1109/TCSVT.2016.2598672.
[41] Abdelaziz Djelouah, Joaquim Campos, Simone Schaub-Meyer, and Christopher Schroers. Neural inter-frame com-pression for video coding. In ICCV, pages 6421-6429 October 2019.
[42] F. Bossen, Common Test Conditions and Software Reference Configurations, document Rec. JCTVC-J1100, Stockholm, Sweden, July 2012.

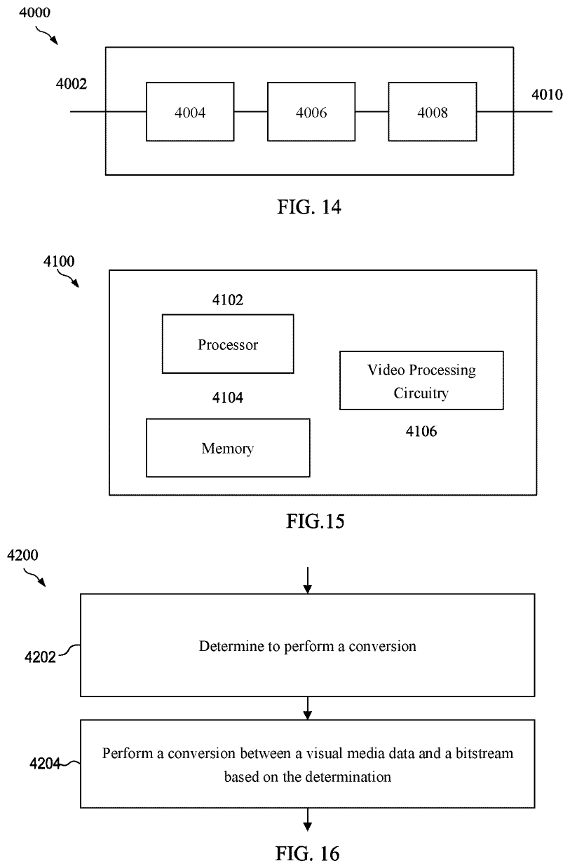

FIG. 14 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 15 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 16 is a flowchart for an example method 4200 of video processing. The method 4200 includes determining to apply a preprocessing function to visual media data as part of an image compression framework at step 4202. A conversion is performed between a visual media data and a bitstream based on the image compression framework at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

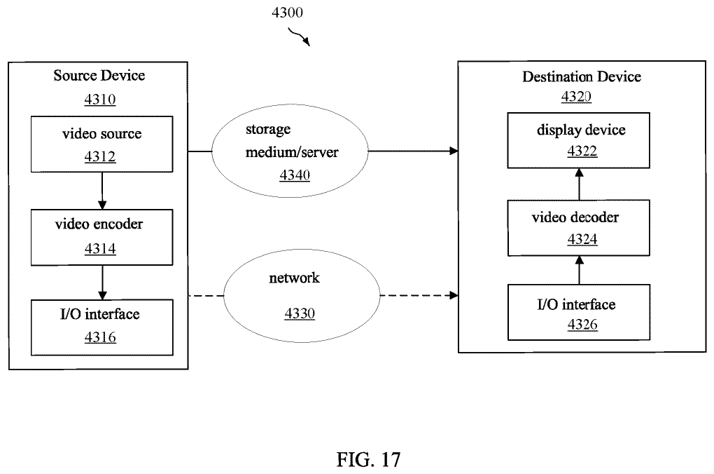

FIG. 17 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

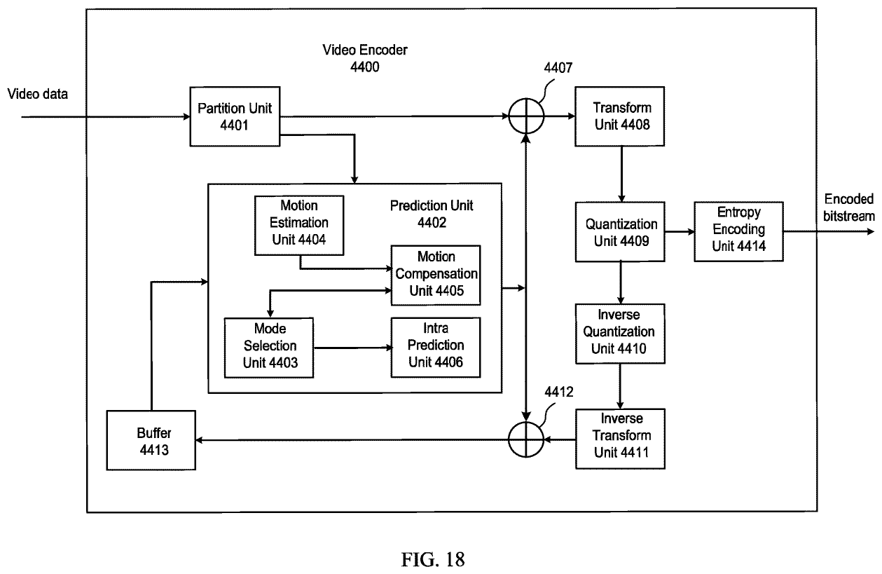

FIG. 18 is a block diagram illustrating an example of video encoder 4400, which may be video encoder 4314 in the system 4300 illustrated in FIG. 6. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

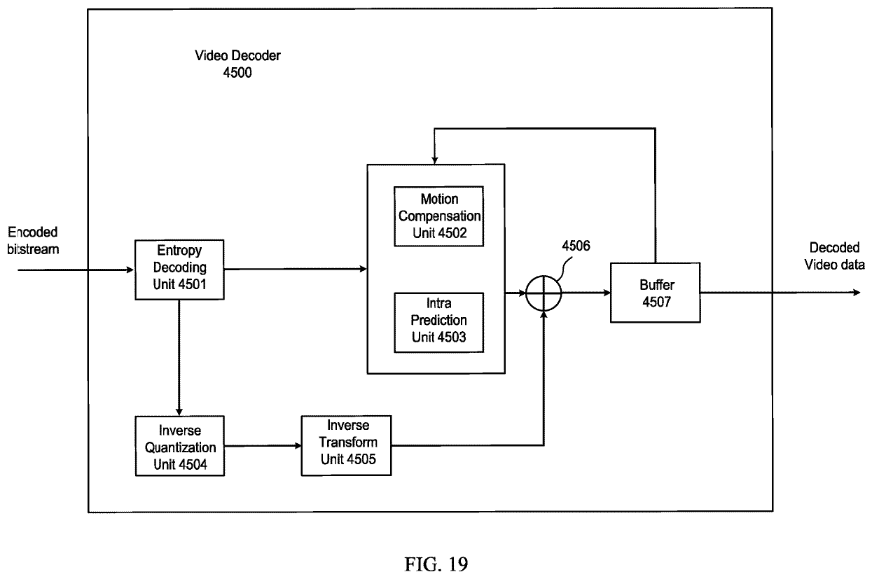

FIG. 19 is a block diagram illustrating an example of video decoder 4500 which may be video decoder 4324 in the system 4300 illustrated in FIG. 6. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

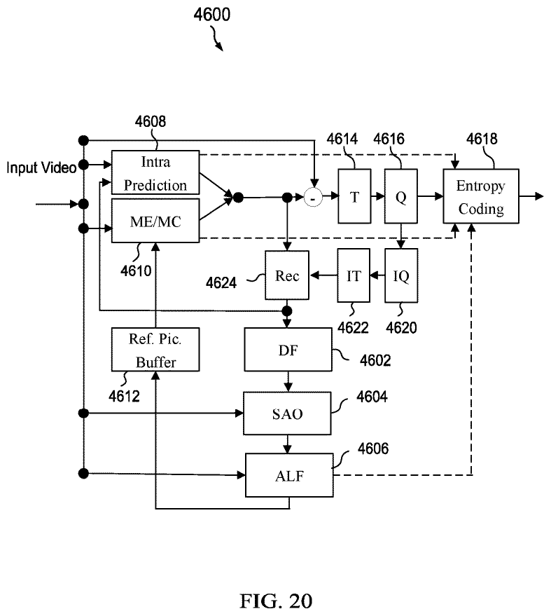

FIG. 20 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

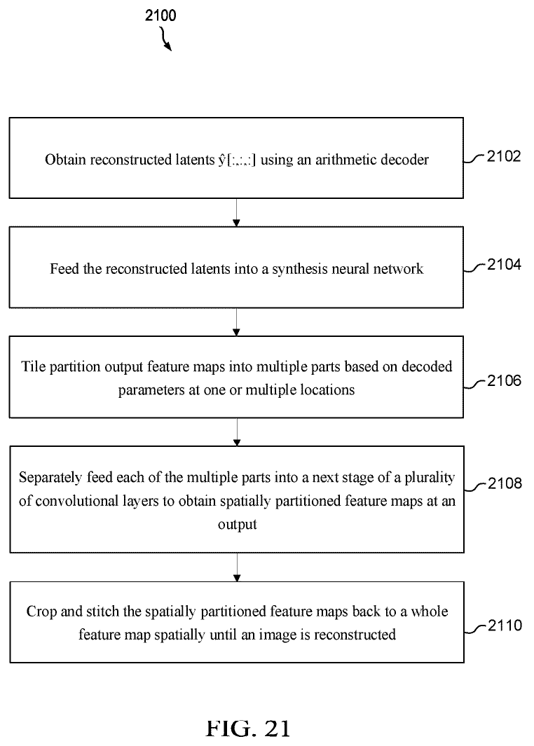

FIG. 21 is an image decoding method 2100 according to an embodiment of the disclosure. The method 2200 may be implemented by an decoding device (e.g., a decoder). In block 2102, the decoding device obtains reconstructed latents ŷ[:,:,:] using an arithmetic decoder. In block 2104, the decoding device feeds the reconstructed latents into a synthesis neural network.

In block 2106, the decoding device tile partitions output feature maps into multiple parts based on decoded parameters at one or multiple locations. In block 2108, the decoding device separately feeds each of the multiple parts into a next stage of a plurality of convolutional layers to obtain spatially partitioned feature maps at an output. In block 2110, the decoding device crops and stitches the spatially partitioned feature maps back to a whole feature map spatially until an image is reconstructed

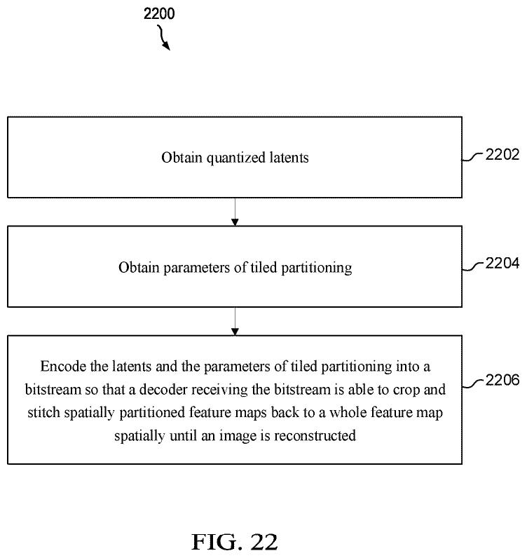

FIG. 22 is an image encoding method 2200 according to an embodiment of the disclosure. The method 2200 may be implemented by an encoding device (e.g., an encoder). In block 2202, the encoding device obtains quantized latents. In block 2204, the encoding device obtains parameters of tiled partitioning. In block 2206, the encoding device encodes the latents and the parameters of tiled partitioning into a bitstream so that a decoder receiving the bitstream is able to crop and stitch spatially partitioned feature maps back to a whole feature map spatially until an image is reconstructed.

A listing of solutions preferred by some examples is provided next.

The following solutions show examples of embodiments discussed herein.
1. An image decoding method, comprising the steps of: obtaining, the reconstructed latents ŷ[:,:,:] using the arithmetic decoder; the reconstructed latents are fed into the synthesis neural network; based on the decoded parameters for tiled partitioning, at one or multiple locations, the output feature maps are tiled partitioned into multiple parts; each part is separately fed into the next stage of convolutional layers to obtain the output spatially partitioned feature maps; the spatially partitioned feature maps are cropped and stitched back to a whole feature map spatially; proceed until the image is reconstructed.
2. An image encoding method, comprising the steps of: obtain the quantized latents and tiled partitioning parameters; and encode the latents and partitioning parameters into the bitstreams.
3. An apparatus for processing video data comprising: a processor; and a non-transitory memory with instructions thereon, wherein the instructions upon execution by the processor, cause the processor to perform.
4. A non-transitory computer readable medium comprising a computer program product for use by a video coding device, the computer program product comprising computer executable instructions stored on the non-transitory computer readable medium such that when executed by a processor cause the video coding device to perform the method of any of claims 1-2.
5. A non-transitory computer-readable recording medium storing a bitstream of a video which is generated by a method performed by a video processing apparatus, wherein the method comprises the method of any of claims 1-2.
6. A method for storing bitstream of a video comprising the method of any of claims 1-2.
7. A method, apparatus, or system described in the present disclosure.

In the solutions described herein, an encoder may conform to a format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, embodiments, systems, subsystems, and methods described and illustrated in the various embodiments as discrete or separate may be combined or integrated with other systems, modules, embodiments, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

The solutions listed in the present disclosure might be used for compressing an image, compressing a video, compression part of an image or compressing part of a video.

In addition, techniques, systems, subsystems, and methods described and illustrated in the various embodiments might be used for compressing an image, compressing a video, compression part of an image or compressing part of a video.

What is claimed is:

1. A method for visual data processing, comprising:
determining, for a conversion between a current visual data unit of visual data and a bitstream of the current visual data unit, tile partitioning information of the current visual data unit; and
performing the conversion by applying neural network module processing based on the tile partitioning information, wherein an input of a layer of a neural network-based coding tool is determined based on the tile partitioning information.

2. The method of claim 1, wherein a flag is included in the bitstream to indicate whether tile partitioning is applied to the current visual data unit.

3. The method of claim 1, wherein tile partitioning for the current visual data unit is performed in a horizontal direction and/or a vertical direction.

4. The method of claim 1, wherein the current visual data unit is split into multiple partitions through tile partitioning; and
wherein a first indication indicating a number of horizontal splits of the current visual data unit is included in the bitstream, and/or
wherein a second indication indicating a number of vertical splits of the current visual data unit is included in the bitstream.

5. The method of claim 4, wherein a size of a partition is determined based on a size of the current visual data unit and indications included in the bitstream, and
wherein the indications include the first indication and the second indication.

6. The method of claim 4, wherein a size of a partition is determined based on a syntax element for indicating a minimum size value.

7. The method of claim 1, wherein the current visual data unit is split into multiple partitions through tile partitioning, and
wherein the multiple partitions are independently coded or dependently coded.

8. The method of claim 7, wherein a flag for indicating whether the multiple partitions are independently coded or dependently coded is included in the bitstream.

9. The method of claim 7, wherein when a partition is obtained through padding, a padding region of the partition is filled using a value corresponding to an adjacent partition.

10. The method of claim 7, wherein when a partition is obtained through padding, a size of a padding region for the partition is fixed.

11. The method of claim 7, wherein when a partition is obtained through padding, a size of a padding region for the partition is determined based on a syntax element included in the bitstream.

12. The method of claim 1, wherein tile partitioning for the current visual data unit is applied at an input of one or more processes of the neural network module processing, and
wherein the one or more processes include synthesis transform.

13. The method of claim 1, wherein the conversion includes encoding the current visual data unit into the bitstream.

14. The method of claim 1, wherein the conversion includes decoding the current visual data unit from the bitstream.

15. An apparatus for processing visual data comprising a processor and a non-transitory memory with instructions thereon, wherein the instructions upon execution by the processor, cause the processor to:
determine, for a conversion between a current visual data unit of visual data and a bitstream of the current visual data unit, tile partitioning information of the current visual data unit; and
perform the conversion by applying neural network module processing based on the tile partitioning information, wherein an input of a layer of a neural network-based coding tool is determined based on the tile partitioning information.

16. The apparatus of claim 15, wherein a flag is included in the bitstream to indicate whether tile partitioning is applied to the current visual data unit.

17. The apparatus of claim 15, wherein the current visual data unit is split into multiple partitions through tile partitioning; and
wherein a first indication indicating a number of horizontal splits of the current visual data unit is included in the bitstream, and/or
wherein a second indication indicating a number of vertical splits of the current visual data unit is included in the bitstream.

18. The apparatus of claim 15, wherein the current visual data unit is split into multiple partitions through tile partitioning, and wherein the multiple partitions are independently coded or dependently coded.

19. The apparatus of claim 18, wherein a flag for indicating whether the multiple partitions are independently coded or dependently coded is included in the bitstream.

20. A non-transitory computer-readable storage medium storing instructions that cause a processor to:
determine, for a conversion between a current visual data unit of visual data and a bitstream of the current visual data unit, tile partitioning information of the current visual data unit; and
perform the conversion by applying neural network module processing based on the tile partitioning information, wherein an input of a layer of a neural network-based coding tool is determined based on the tile partitioning information.
